(19) United States
(12) Patent Application Publication
(10) Pub. No.: US 2014/0097371 A1
(43) Pub. Date: Apr. 10, 2014

(54) PIGGING BALL VALVE

(71) Applicant: ARRAY HOLDINGS, INC., Houston, TX (US)

(72) Inventor: Ly-Trong Van Huynh, Houston, TX (US)

(73) Assignee: Array Holdings, Inc., Houston, TX (US)

(21) Appl. No.: 13/645,178

(22) Filed: Oct. 4, 2012

(51) Int. Cl. F16K 5/06

(52) U.S. Cl. CPC F16K 5/0605
USPC 251/315.16; 29/890.12

(57) ABSTRACT

Improved ball valve or pig valves with stems having higher stress yields are disclosed. Additionally, a method of changing using the same stem in a ball valve or pig valve in a low pressure application or a high pressure application is disclosed. Furthermore, a method of ensuring a correct stem is matched to a correct ball of a ball or pig valve is disclosed.

### FIELD

The invention relates generally to ball valves, related systems, and methods of use. In particular the invention relates to improved ball valves with trunnions having higher stress yields and ball valves wherein pressure in the valve is better distributed.

### BACKGROUND

Ball valves are known in the art, and have traditionally been used as an effective mechanism for regulating fluid flow in various conduits. Various structural arrangements have been achieved for interrupting fluid flow by twisting a handle of a ball valve, and resuming fluid flow by twisting the handle back again. Typically, ball valves include a housing having an inlet port and an outlet port. A throughbore internally connects the inlet port to the outlet port. An inlet conduit and an outlet conduit may be connected to the inlet port and the outlet port respectively. A central chamber is positioned in the path of the throughbore. A ball with a throughbore is positioned within the central chamber. The ball may be rotated by an external handle. When the handle is twisted to align the throughbore of the ball with the path of the throughbore, the throughbore is uninterrupted and fluid may flow between the inlet and outlet ports. When the handle is twisted so that the slot lies perpendicular to the throughbore, fluid flow is interrupted.

Three-way ball valves have an L- or T-shaped hole through the middle. Typically, a T valve can connect any pair of ports, or all three, together. The 45 degree position typically disconnects all three valves. Generally, the L valve can connect the center port to either side port, or disconnect all three, but it cannot connect the side ports together.

Multi-port ball valves with 4 ways, or more, are also commercially available, the inlet way often being orthogonal to the plane of the outlets. For special applications, such as driving air-powered motors from forward to reverse, the operation is performed by rotating a single lever four-way valve. The 4-way ball valve has two L-shaped ports in the ball that do not interconnect, sometimes referred to as an “x” port.

In ball valves, the stem is the component that allows valve operators to open and close the valve by quarter turns. Typically, a stem is comprised of three sections, which are arranged in a specific order. This order is the stem shaft followed by a non-cylindrical section that drives the ball, known as the stem tang, and then followed by a cylindrical shaped section that acts as a trunnion, also known as a stem upset.

Typically ball valves used as pig valves require the use of a heavier, larger trunnion. However, the cylindrical section acting as the trunnion will always be limited to a smaller diameter because it follows the non-cylindrical section. In such cases, a smaller trunnion is typically less rigid and has a lower stress yield. This would prevent the trunnion from being used interchangeably from low pressure to high pressure applications for valves of the same size. In addition, pig valves typically require a second trunnion on the opposite end of the ball. With this existing design, the second trunnion is sized at a larger diameter resulting in an imbalance in force acting on each trunnion.

Rearrangement of the stem of a ball valve in order to allow a larger trunnion with a larger diameter would be advantageous. The force acting on the trunnion would result in a higher stress yield. Such a higher stress yield would be ideal for pig valves considering the fixed position that the ball must maintained at in order for the valve to operate properly. Having a larger trunnion would also makes it reasonably acceptable to size the second trunnion on the opposite end of the ball to the same diameter size. As a result, the pressure in the valve would be distributed over an equal area on both ends of the ball.

### SUMMARY

Particular embodiments of the invention pertain to an improved ball valve comprising: a ball valve case having a first valve bore and a second valve bore; a ball situated within said ball valve case and said ball having a throughbore defining a flow axis; a stem shaft having a proximal end and a distal end; a stem upset having a proximal end and a distal end, the distal end connected to the proximal end of the stem shaft; a stem tang having a proximal end and a distal end, the distal end connected to the proximal end of the stem upset, the stem tang also having a non-circular shape; and wherein the ball has a stem upset slot having a distal end and a proximal end, the proximal end having a tang slot, and wherein the stem upset slot is adapted to receive the stem upset and the tang slot is adapted to receive the stem tang.

Still further, in the embodiments of the invention, the first valve bore may be connected to a first pipe and the second valve bore may be connected to a second pipe such that when the flow axis of said throughbore is at least partially aligned with respect to the flow axis of said first valve bore and said second valve bore, a fluid is capable of flowing through the first pipe, the ball valve case, and the second pipe.

In embodiments of the invention pertaining to the throughbore of the ball valve, the throughbore of the ball may be substantially circular. Additionally, in certain embodiments the throughbore of the ball may be a diameter greater than or equal to the inner diameter of the first pipe. Still further the throughbore of the ball may be greater than or equal to the outer diameter of a pig capable of flowing through the first pipe. Furthermore, the throughbore of the ball may be adapted to receive a pig. In such embodiments the throughbore has distal ends, and one of the distal ends may be connected to a basket for retaining the pig.

Other embodiments of the invention pertain to the stem tang, wherein the stem tang has a positive shape extending in a proximal direction from the stem upset and the tang slot has a reciprocal negative shape extending in a proximal direction from the stem upset slot. In further embodiments pertaining to the stem tang, when torque is applied to the stem shaft, this may cause the stem tang to apply torque to the tang slot, thereby causing the ball to at least partially rotate. In such embodiments, the rotation of the ball at least partially inhibits fluid flow.

In embodiments of the invention pertaining to the stem upset or the stem tang, the stem upset is cylindrical and the proximal end of the stem upset has a defined area. Likewise, the proximal end of the stem tang has a defined area less than the defined area of the stem upset.

In embodiments of the invention pertaining to the entire stem, the stem shaft, the stem upset and the stem tang are connected by welding, casting, forging or milling.

Other embodiments of the invention pertain to a method of using the same stem in a ball valve in both low fluid pressure applications and high fluid pressure applications, the method comprising: obtaining a ball valve case having a first valve bore and a second valve bore, with a ball situated within said ball valve case and said ball having a throughbore defining a flow axis, the ball further having a stem upset slot having a distal end and a proximal end and a tang slot positioned at the proximal end of the stem upset slot, wherein the stem upset slot is adapted to receive the stem upset and the tang slot is adapted to receive the stem tang; obtaining a stem, the stem comprising a stem shaft having a proximal end and a distal end, a stem upset having a proximal end and a distal end, and a stem tang having a proximal and distal end, the distal end of the stem upset connected to the proximal end of the stem shaft and the distal end of the stem tang connected to the proximal end of the stem upset; wherein the stem upset is cylindrical with the proximal end having a defined area and the stem tang is non-cylindrical with the proximal end of the stem tang having a defined area less than the defined area of the stem upset; and wherein having a stem upset with a proximal end area greater than the proximal end area of the stem tang increases rigidity of the stem upset and increases the stress yield.

In embodiments of the invention pertaining to low pressure and high pressure applications, a low pressure application may be between about 1 to about 500 pounds per square inch, and a high pressure application may be between about 500 and 20,000 pounds per square inch.

In further embodiments of the method, the throughbore may have at least one distal end connected to a basket and the ball valve is a pig valve.

Other embodiments of the invention pertain to a method of insuring that the correct stem is fitted to the correct ball of a ball valve, the method comprising: obtaining a ball valve case having a first valve bore and a second valve bore, with a ball situated within said ball valve case and said ball having a throughbore defining a flow axis, the ball further having a stem upset slot having a distal end and a proximal end and a tang slot positioned at the proximal end of the stem upset slot, wherein the stem upset slot is adapted to receive the stem upset and the tang slot is adapted to receive the stem tang; obtaining a stem, the stem comprising a stem shaft having a proximal end and a distal end, a stem upset having a proximal end and a distal end, and a stem tang having a proximal and distal end, the distal end of the stem upset connected to the proximal end of the stem shaft and the distal end of the stem tang connected to the proximal end of the stem upset; wherein the stem upset is cylindrical with the proximal end having a defined area and the stem tang is non-cylindrical with the proximal end of the stem tang having a defined area less than the defined area of the stem upset; wherein the stem tang has a positive shape extending in a proximal direction from the stem upset and the tang slot has a reciprocal negative shape extending in a proximal direction from the stem upset slot.

In specific embodiments of this method, if the tang slot does not have a reciprocal negative shape compared to the positive shape of the stem tang, the stem is incorrect for the ball valve. Likewise, if the tang slot does have a reciprocal negative shape compared to the positive shape of the stem tang, the stem is correct for the ball valve.

### BRIEF DESCRIPTION OF THE DRAWINGS

In order that the manner in which the above-recited and other enhancements and objects of the invention are obtained, a more particular description of the invention briefly described above will be rendered by reference to specific embodiments thereof which are illustrated in the appended drawings. Understanding that these drawings depict only typical embodiments of the invention and are therefore not to be considered limiting of its scope, the invention will be described with additional specificity and detail through the use of the accompanying drawings in which:

FIG. 1 is an illustration of embodiment of the stem of the present invention.

FIG. 2 is an illustration of a traditional stem.

FIG. 3 is a cross sectional illustration of a stem attached to a ball of a ball valve.

FIG. 4 is an illustration of a stem and ball depicting a stem upset slot, a stem tang slot and a ball throughbore.

### LIST OF REFERENCE NUMERALS

stem shaft 10
sealing grooves 20
stem upset 30
stem tang 40
traditional stem shaft 50
traditional sealing grooves 60
traditional stem tang 70
traditional stem upset 80
stem 85
ball 90
valve body 100
stem bonnet 110
bolts 120
o-rings 130
bearing 140
thrust bearing 150
stem upset slot 160
tang slot 180
valve bore 190

### DETAILED DESCRIPTION

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “conduit” means and refers to a fluid flow path.

As used herein, the term “line” means and refers to a fluid flow path.

As used herein, the term “fluid” refers to a non-solid material such as a gas, a liquid or a colloidal suspension capable of being transported through a pipe, line or conduit. Examples of fluids include by way of non-limiting examples the following: natural gas, propane, butane, gasoline, crude oil, mud, water, nitrogen, sulfuric acid and the like.

As used herein, the term “attached,” or any conjugation thereof describes and refers to the at least partial connection of two items.

As used herein, the term “stem” refers to a ball valve stem comprising a plurality of sections.

As used herein, the term “stem shaft” refers to a section of stem comprising seal grooves used to contain pressure and fluid being processed through the valve.

As used herein, the term “stem upset” refers to a cylindrical section of the stem which acts as a trunnion.

As used herein, the term “proximal” refers to a direction toward the center of the ball valve.

As used herein, the term “distal” refers to a direction away from the center of the ball valve.

As used herein, the term “trunnion” refers to a rigid component of a stem that maintains the fixed position of the ball in a ball valve in all degrees of motion within the valve except for the rotational motion when the valve is opening and closing.

As used herein, the term “stem tang” refers to the non-cylindrical feature of the stem that drives the ball open and closed.

As used herein, the term “tang slot” refers to an indentation in the ball of a ball valve adapted to receive the stem tang, wherein the indentation is the negative shape of the stem tang.

The embodiments of the invention herein relate to ball valves and in certain instances, to pigging valves, which are designed to release or capture a pipeline device known as a pig, which can be used to clean or inspect pipeline.

In certain embodiments, the invention relates to a stem used in a ball valve with stem components in a particular order. In such embodiments, such as with an inverted trunnion style stem, the order may be a stem shaft followed by a stem upset, which is followed by a stem tang. In such embodiments, the stem shaft section comprises seal grooves which may be used to contain pressure and fluids being processed through the valve. Still further, the stem upset comprises the cylindrical section of the stem which acts as a trunnion.

In embodiments pertaining to the stem upset, the stem upset may be fitted into a partial bore of a ball in a ball valve such as a stem upset slot. In such embodiments, the partial bore of the ball valve is machined to a certain depth into the ball. In other embodiments, the partial bore of the ball valve is made during a forging or casting process. In any embodiment, the partial bore is an indentation adapted to receive the stem upset.

Following the stem upset is the stem tang. In certain embodiments, the stem tang is initially a cylindrical shape, but with two parallel flats milled equal distance from the centerline. The stem tang interfaces with the tang slot at the bottom of the partial bore of the ball. Typically, the tang slot is milled to a certain depth and adapted to receive the stem tang. However, like the partial bore of the ball, the tang slot can be cast or forged in the process of making the ball. In additional embodiments, the stem tang and the corresponding tang slot are not necessarily centerline and with two parallel flats, but instead one of any variety of shapes, such as a “+” or a star shape or a hexagonal shape and so on.

In additional embodiments regarding the stem tang and the tang slot, when the tang slot receives the stem tang, the stem may be rotated, such that the ball is driven in one direction or another from the torque and contact made between the stem tang and the tang slot.

In the foregoing embodiments, the advantage of the invention over existing designs is that there is less limitation on the size of the stem upset due to its positioning on the stem.

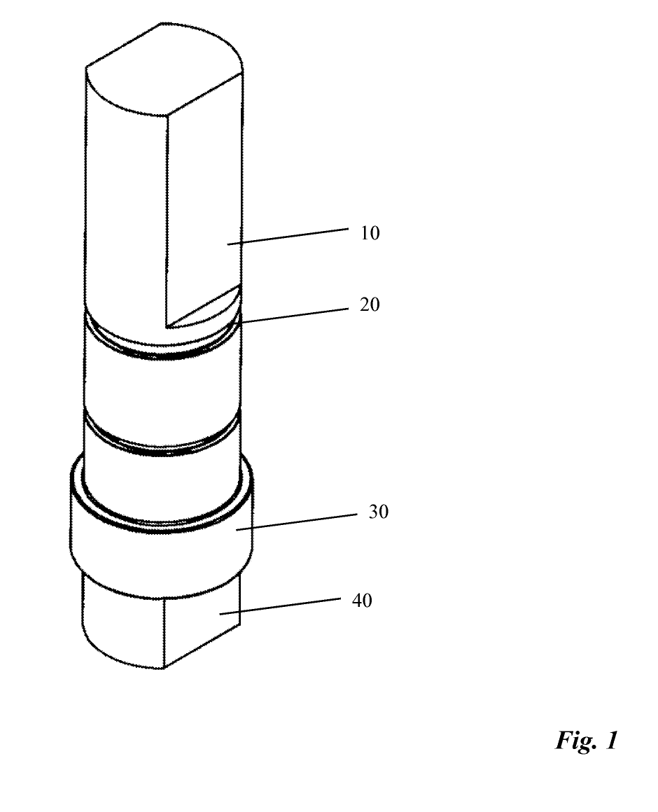

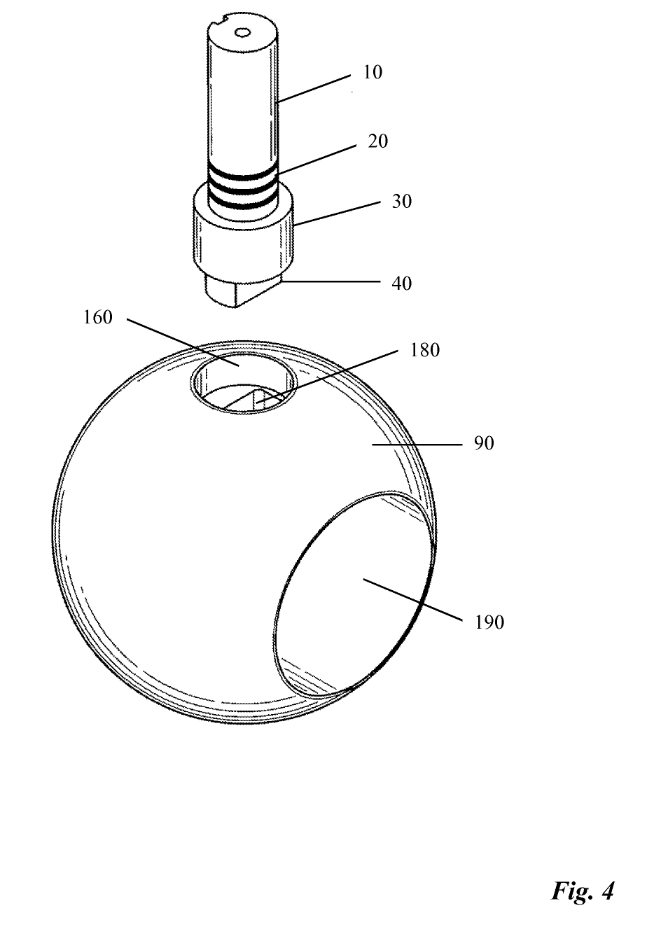

Referring to the drawings, as shown in FIG. 1 is an embodiment of the stem of the present invention. As seen in FIG. 1, the inverted trunnion style stem has, at its most distal end, a stem shaft 10. The stem shaft comprises a non-cylindrical section followed by a cylindrical section having sealing grooves 20 used to contain pressure and fluid being processed through the valve. Proximal to the stem shaft is the stem upset 30. The stem upset 30 is a cylindrical section which acts as a trunnion. The stem upset 30 slides into the stem upset slot 160 as shown in FIG. 4 that is a certain depth within the ball 90 of the ball valve. Referring again to FIG. 1, immediately proximal to the stem upset 30 is the stem tang 40, which slides into the tang slot 180 within the stem upset slot as depicted in FIG. 4. In FIG. 1, the stem tang 40 is depicted as an originally cylindrical shape with two parallel flats milled equal distance from the stem centerline. However, the stem tang 40 can be any shape except cylindrical so long as it fits within the tang slot which is shaped to be the negative of the stem tang 40.

Still referring to the stem tang 40, it may, in certain instances, be advantageous to have different shaped stem tangs for stems needed in different applications. In this manner, an improper stem cannot be inserted into the stem upset slot of a ball valve. By having differently shaped stem tangs and stem slots, a user will be sure to install the correct stem into the correct ball valve.

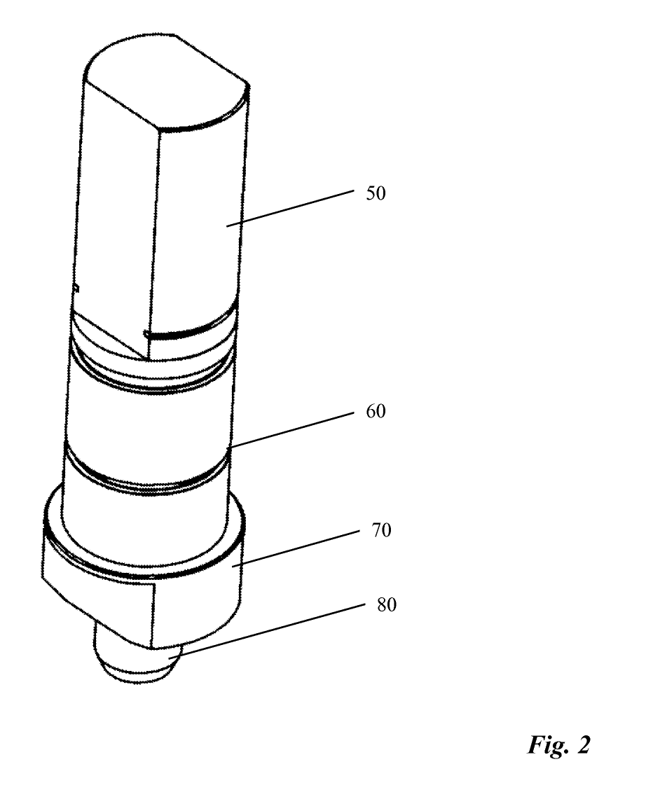

In contrast to the improved inverted trunnion style stem as depicted in FIG. 1, FIG. 2 depicts a traditional stem. In the traditional stem, a traditional stem shaft 50 is located at its most distal end. As seen in the figure, the traditional stem shaft 50 comprises a non-cylindrical section followed by a cylindrical section having traditional sealing grooves 60. In contrast to the improved trunnion style stem depicted in FIG. 1, in FIG. 2, the section immediately proximal to the traditional stem shaft 50 is a traditional stem tang 70. Like FIG. 1, the traditional stem tang 70 is cylindrical in shape with two parallel flats milled equal distance from the stem centerline. However, the traditional stem tang 70 is more limited in possible shapes that can be made as the center of its proximal end must be attached to a traditional stem upset 80. Additionally, the traditional stem upset 80 must always be smaller than the traditional stem tang. This can be a disadvantage, because for ball valves and pig valves, a small trunnion would be less rigid, thus preventing the stem from being used interchangeably from low pressure to high pressure applications for valves of the same size.

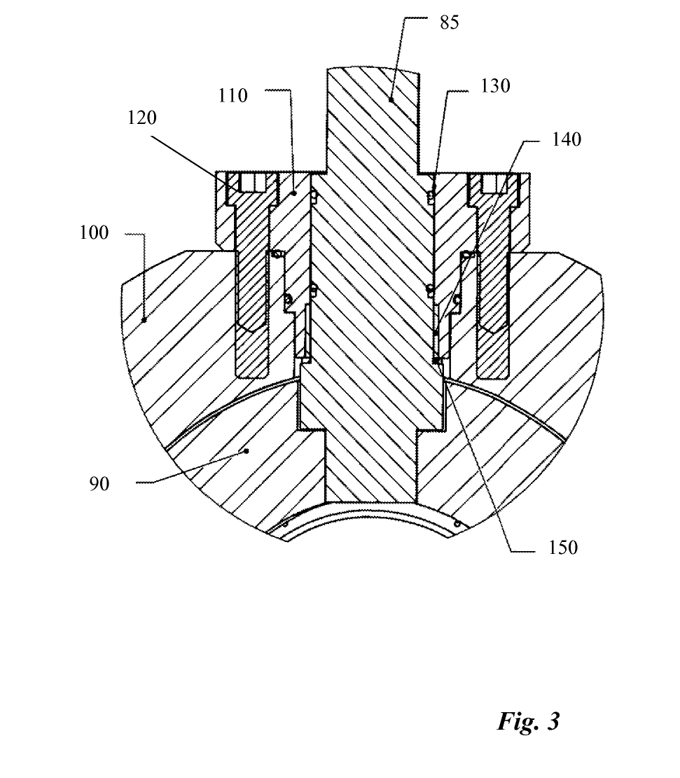

In certain instances the stem is positioned within the ball or pig valve body in such a manner that it may be exchanged for a different stem, depending on the application. As illustrated in FIG. 3, the stem 85 is positioned such that its proximal end, where the stem tang is located, is within the ball 90. Distal to the ball is the valve body 100, through which the stem 80 also passes. The stem 85 is held in place by the stem bonnet 110 which is distal to the valve body. The stem bonnet 110 may be secured to the valve body 100 through bolts 120. To prevent fluid loss and pressure loss, the stem 85 has o-rings 130 surrounding the portion of the stem 85 between the stem 85 and the stem bonnet 110. To aid in rotation of the stem 85, between the stem 85 and the stem bonnet 110 is at least one bearing 140, which is immediately distal to a thrust bearing 150.

As indicated above, FIG. 4 is an illustration of the stem being inserted into the ball 90 of the ball valve. More particularly the inverted trunnion style stem has, at its most distal end, a stem shaft 10. The stem shaft 10 comprises a non-cylindrical section followed by a cylindrical section having sealing grooves 20 used to contain pressure and fluid being processed through the valve. Proximal to the stem shaft 10 is the stem upset 30. The stem upset 30 is a cylindrical section which acts as a trunnion. The stem upset 30 slides into the stem upset slot 160 that is a certain depth within the ball 90 of the ball valve. Immediately proximal to the stem upset 30 is the stem tang 40, which slides into the tang slot 180 within the stem upset slot 160. Further, the ball 90 possesses a valve bore 190 into which a pig may be inserted or fluid may pass.

In implementation, a stem 85, comprising a stem shaft 10, a stem upset 30 and a stem tang 40, may be inserted into the stem upset slot 160 located within the ball 90. Upon insertion, the stem tang 40, which may be of a certain shape, enters the tang slot 180. The shape of the tang slot 180 in comparison to the shape of the stem tang 40 will prevent the incorrect stem 85 from being used with an unsuitable ball 90. Upon correct insertion, a wheel or other mechanical device can be attached to the distal end of the stem shaft 10 and rotate the stem 85, which causes a rotational force to be applied on the tang slot by the stem tang 40.

1. An improved ball valve comprising:
a ball valve case having a first valve bore and a second valve bore;
a ball situated within said ball valve case and said ball having a throughbore defining a flow axis;
a stem shaft having a proximal end and a distal end;
a stem upset having a proximal end and a distal end, the distal end connected to the proximal end of the stem shaft;
a stem tang having a proximal end and a distal end, the distal end connected to the proximal end of the stem upset, the stem tang also having a non-circular shape; and
wherein the ball has a stem upset slot having a distal end and a proximal end, the proximal end having a tang slot, and wherein the stem upset slot is adapted to receive the stem upset and the tang slot is adapted to receive the stem tang.

2. The ball of claim 1, wherein the first valve bore is connected to a first pipe and the second valve bore is connected to a second pipe such that when the flow axis of the throughbore is at least partially aligned with respect to the flow axis of said first valve bore and said second valve bore, a fluid is capable of flowing through the first pipe, the ball valve case, and the second pipe.

3. The ball valve of claim 2, wherein the throughbore of the ball is substantially circular.

4. The ball valve of claim 3, wherein the throughbore of the ball is a diameter greater than or equal to the inner diameter of the first pipe.

5. The ball valve of claim 4, wherein the throughbore of the ball is greater than or equal to the outer diameter of a pig capable of flowing through the first pipe.

6. The ball valve of claim 5, wherein the throughbore of the ball is adapted to receive the pig.

7. The ball valve of claim 6, wherein the throughbore has distal ends, one of the distal ends connected to a basket for retaining the pig.

8. The ball valve of claim 1, wherein the stem tang has a positive shape extending in a proximal direction from the stem upset and the tang slot has a reciprocal negative shape extending in a proximal direction from the stem upset slot.

9. The ball valve of claim 8, wherein torque applied to the stem shaft causes the stem tang to apply torque to the tang slot, thereby causing the ball to at least partially rotate.

10. The ball valve of claim 9, wherein rotation of the ball at least partially inhibits fluid flow.

11. The ball valve of claim 1, wherein the stem upset is cylindrical and the proximal end of the stem upset has a defined area.

12. The ball valve of claim 11, wherein the proximal end of the stem tang has a defined area less than the defined area of the stem upset.

13. The ball valve of claim 1, wherein the stem shaft, the stem upset and the stem tang are connected by welding, casting, forging or milling.

14. A method of using the same stem in a ball valve in both low fluid pressure applications and high fluid pressure applications, the method comprising:
obtaining a ball valve case having a first valve bore and a second valve bore, with a ball situated within said ball valve case and said ball having a throughbore defining a flow axis, the ball further having a stem upset slot having a distal end and a proximal end and a tang slot positioned at the proximal end of the stem upset slot, wherein the stem upset slot is adapted to receive the stem upset and the tang slot is adapted to receive the stem tang;
obtaining a stem, the stem comprising a stem shaft having a proximal end and a distal end, a stem upset having a proximal end and a distal end, and a stem tang having a proximal and distal end, the distal end of the stem upset connected to the proximal end of the stem shaft and the distal end of the stem tang connected to the proximal end of the stem upset;
wherein the stem upset is cylindrical with the proximal end having a defined area and the stem tang is non-cylindrical with the proximal end of the stem tang having a defined area less than the defined area of the stem upset; and
wherein having a stem upset with a proximal end area greater than the proximal end area of the stem tang increases rigidity of the stem upset and increases the stress yield.

15. The method of claim 14, wherein the stem is used in a low pressure application of between about 1 to about 500 pounds per square inch.

16. The method of claim 14, wherein the stem is used in a high pressure application of between about 500 and 20,000 pounds per square inch.

17. The method of claim 14, wherein the throughbore has at least one distal end connected to a basket and the ball valve is a pig valve.

18. A method of insuring that the correct stem is fitted to the correct ball of a ball valve, the method comprising:
obtaining a ball valve case having a first valve bore and a second valve bore, with a ball situated within said ball valve case and said ball having a throughbore defining a flow axis, the ball further having a stem upset slot having a distal end and a proximal end and a tang slot positioned at the proximal end of the stem upset slot, wherein the stem upset slot is adapted to receive the stem upset and the tang slot is adapted to receive the stem tang;
obtaining a stem, the stem comprising a stem shaft having a proximal end and a distal end, a stem upset having a proximal end and a distal end, and a stem tang having a proximal and distal end, the distal end of the stem upset connected to the proximal end of the stem shaft and the distal end of the stem tang connected to the proximal end of the stem upset;
wherein the stem upset is cylindrical with the proximal end having a defined area and the stem tang is non-cylindrical with the proximal end of the stem tang having a defined area less than the defined area of the stem upset;
wherein the stem tang has a positive shape extending in a proximal direction from the stem upset and the tang slot has a reciprocal negative shape extending in a proximal direction from the stem upset slot.

19. The method of claim 18, wherein if the tang slot does not have a reciprocal negative shape compared to the positive shape of the stem tang, the stem is incorrect for the ball valve.

20. The method of claim 18, wherein if the tang slot does have a reciprocal negative shape compared to the positive shape of the stem tang, the stem is correct for the ball valve.
